(19) United States
(12) Patent Application Publication
(10) Pub. No.: US 2011/0157027 A1
(43) Pub. Date: Jun. 30, 2011

(54) Method and Apparatus for Performing an Operation on a User Interface Object

(75) Inventor: Tero Pekka Rissa, Siivikkala (FI)

(73) Assignee: NOKIA CORPORATION, Espoo (FI)

(21) Appl. No.: 12/650,252

(22) Filed: Dec. 30, 2009

(51) Int. Cl. G06F 3/048; G06F 3/041

(52) U.S. Cl. 345/173; 715/764

(57) ABSTRACT

In accordance with an example embodiment of the present invention, there is provided a method comprising dividing at least a part of a user interface object into a grid comprising multiple cells, associating an operation with a cell in the grid and in response to detecting an action on the cell performing the associated operation on the user interface object.

### TECHNICAL FIELD

The present application relates generally to an input method in an apparatus. The present application relates in an example to a single input method in a touch sensitive apparatus.

### BACKGROUND

Currently there several different kinds of apparatuses with several different kinds of input methods. For example, today with touch screen devices there are at least two kinds of input methods, namely single touch and multi touch methods. Research in the field of input methods aim at finding the most natural and easy ways to input and to access information in different kinds of devices.

### SUMMARY

Various aspects of examples of the invention are set out in the claims.

According to a first aspect of the present invention, there is provided a method comprising: dividing at least a part of a user interface object into a grid comprising multiple cells, associating an operation with a cell in the grid and in response to detecting an action on the cell performing the associated operation on the user interface object.

According to a second aspect of the present invention, there is provided an apparatus, comprising: a processor, memory including computer program code, the memory and the computer program code configured to, working with the processor, cause the apparatus to perform at least the following: divide at least a part of a user interface object into a grid comprising multiple cells, associate an operation with a cell in the grid and perform the associated operation on the user interface object in response to detecting an action on the cell.

According to a third aspect of the present invention, there is provided a computer program product comprising a computer-readable medium bearing computer program code embodied therein for use with a computer, the computer program code comprising: code for dividing at least a part of a user interface object into a grid comprising multiple cells, code for associating an operation with a cell in the grid and code for performing the associated operation on the user interface object in response to detecting an action on the cell.

According to a fourth aspect of the present invention, there is provided an apparatus comprising: means for dividing at least a part of a user interface object into a grid comprising multiple cells, means for associating an operation with a cell in the grid and means for performing the associated operation on the user interface object in response to detecting an action on the cell.

### BRIEF DESCRIPTION OF THE DRAWINGS

For a more complete understanding of example embodiments of the present invention, reference is now made to the following descriptions taken in connection with the accompanying drawings in which:

FIG. 1 shows a block diagram of an example apparatus in which aspects of the disclosed embodiments may be applied;

FIG. 2 illustrates an exemplary user interface incorporating aspects of the disclosed embodiments;

FIG. 3 illustrates a user interface object divided into a grid in accordance with an example embodiment of the invention;

FIG. 4 illustrates another user interface object divided into a grid in accordance with an example embodiment of the invention;

FIG. 5 illustrates an exemplary process incorporating aspects of the disclosed embodiments; and

FIG. 6 illustrates another user interface object divided into a grid in accordance with an example embodiment of the invention.

### DETAILED DESCRIPTION OF THE DRAWINGS

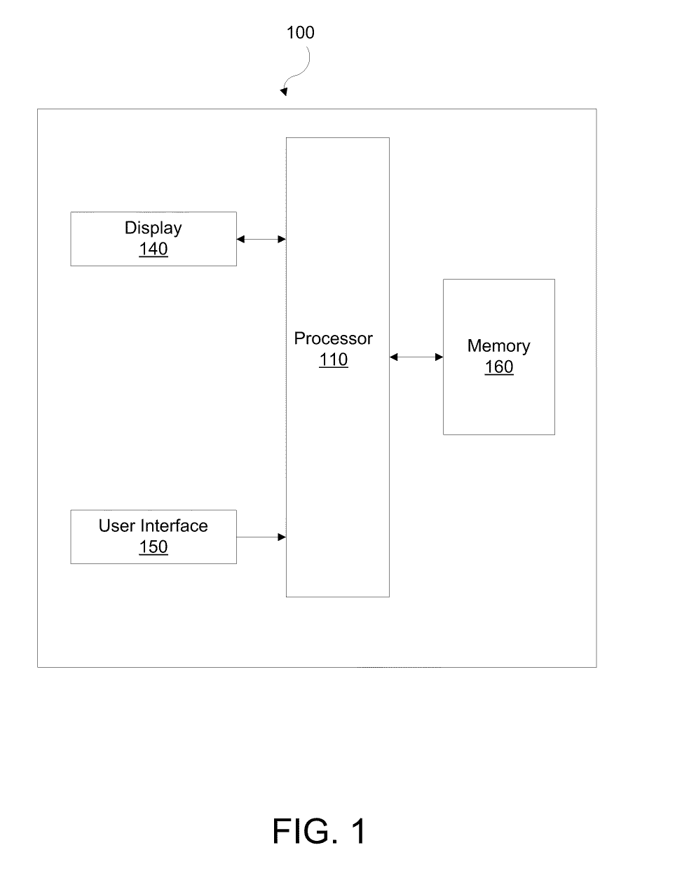

An example embodiment of the present invention and its potential advantages are understood by referring to FIGS. 1 through 6 of the drawings.

The aspects of the disclosed embodiments relate to user operations on an apparatus. In particular, some examples relate to performing one or more actions on a user interface object. In some exemplary embodiments a technique for performing an action by single input in an apparatus is disclosed. In some exemplary embodiments single input comprises a starting point in a pre-determined area. In some exemplary embodiments single input comprises a starting point in a pre-determined area and a continuous path. In some exemplary embodiments single input comprises a starting point in a pre-determined area and a continuous path of a pre-determined shape. In some examples single input comprises a touch gesture. In some examples single input comprises a single touch.

FIG. 1 is a block diagram depicting an apparatus 100 operating in accordance with an example embodiment of the invention. Generally, the electronic device 100 includes a processor 110, a memory 160, a user interface 150 and a display 140.

In the example of FIG. 1, the processor 110 is a control unit that is connected to read and write from the memory 160 and configured to receive control signals received via the user interface 150. The processor 110 may also be configured to convert the received control signals into appropriate commands for controlling functionalities of the apparatus. In another exemplary embodiment the apparatus may comprise more than one processor.

The memory 160 stores computer program instructions which when loaded into the processor 110 control the operation of the apparatus 100 as explained below. In another exemplary embodiment the apparatus 100 may comprise more than one memory 160 or different kinds of storage devices.

The user interface 150 comprises means for inputting and accessing information in the apparatus 100. In one exemplary embodiment the user interface 150 may also comprise the display 140. For example, the user interface 150 may comprise a touch screen display on which user interface objects can be displayed and accessed. In one exemplary embodiment, a user may input and access information by using a suitable input means such as a pointing means, one or more fingers or a stylus. In one embodiment inputting and accessing information is performed by touching the touch screen display. In another exemplary embodiment proximity of an input means such as a finger or a stylus may be detected and inputting and accessing information may be performed without a direct contact with the touch screen.

In another exemplary embodiment, the user interface 150 comprises a manually operable control such as button, a key, a touch pad, a joystick, a stylus, a pen, a roller, a rocker or any suitable input means for inputting and/or accessing information. Further examples are a microphone, a speech recognition system, eye movement recognition system, acceleration, tilt and/or movement based input system.

The exemplary apparatus 100 of FIG. 1 also includes an output device. According to one embodiment the output device is a display 140 for presenting visual information for a user. The display 140 is configured to receive control signals provided by the processor 110. The display 140 may be configured to present user interface objects. However, it is also possible that the apparatus 100 does not include a display 140 or the display is an external display, separate from the apparatus itself. According to one exemplary embodiment the display 140 may be incorporated within the user interface 150.

In a further embodiment the apparatus 100 includes an output device such as a tactile feedback system for presenting tactile and/or haptic information for a user. The tactile feedback system may be configured to receive control signals provided by the processor 110. The tactile feedback system may be configured to indicate a completed operation or to indicate selecting an operation, for example. In one embodiment a tactile feedback system may cause the apparatus 100 to vibrate in a certain way to inform a user an activated and/or completed operation.

The apparatus may be an electronic device such as a hand-portable device, a mobile phone or a personal digital assistant (PDA), a personal computer (PC), a laptop, a desktop, a wireless terminal, a communication terminal, a game console, a music player, a CD- or DVD-player or a media player.

Computer program instructions for enabling implementations of example embodiments of the invention or a part of such computer program instructions may be downloaded from a data storage unit to the apparatus 100 by the manufacturer of the apparatus 100, by a user of the apparatus 100, or by the apparatus 100 itself based on a download program or the instructions can be pushed to the apparatus 100 by an external device. The computer program instructions may arrive at the apparatus 100 via an electromagnetic carrier signal or be copied from a physical entity such as a computer program product, a memory device or a record medium such as a CD-ROM or DVD.

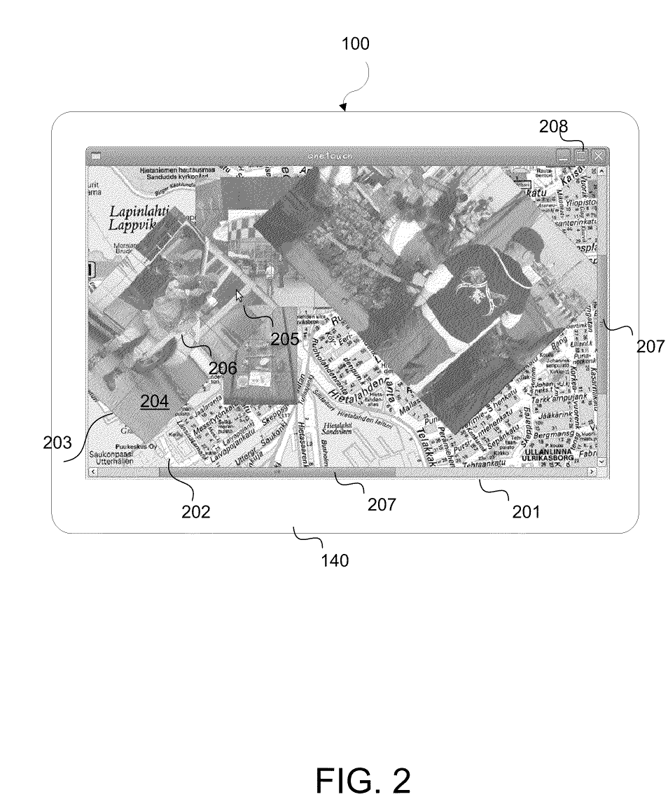

FIG. 2 illustrates an exemplary user interface incorporating aspects of the disclosed embodiments. An apparatus 100 comprises a display 140 for presenting user interface objects. The exemplary apparatus 100 of FIG. 2 may also comprise one or more keys and/or additional and/or other components. In one embodiment a pointing means such as a cursor 205 controlled by a computer mouse or a stylus or a digital pen, for example, may be used for inputting and accessing information in the apparatus 100. In another embodiment the display 140 of the apparatus 100 may be a touch screen display incorporated within the user interface 150 which allows inputting and accessing information via the touch screen.

The exemplary user interface of FIG. 2 comprises an application window 201 presenting user interface objects such as a map application 202 and a picture 203 on top of the map application 202. The application window 201 also comprises scroll bars 207 to scroll the content of the application window in horizontal and/or vertical direction. In some example embodiments a user interface object may be any image or image portion that is presented to a user on a display. In some example embodiments a user interface object may be any graphical object that is presented to a user on a display. In some example embodiments a user interface object may be any selectable and/or controllable item that is presented to a user on a display. In some example embodiments a user interface object may be any information carrying item that is presented to a user on a display. In some embodiments an information carrying item comprises a visible item with a specific meaning to a user. In the example of FIG. 2, the user interface objects presented by the display 140 comprise at least the application window 201, the map application 202, the picture 203 and the scroll bars 207. In another embodiment the user interface objects presented by the display 140 may additionally or alternatively comprise a part of an application window and/or other user interface objects such as icons, files, folders, widgets or an application such as a web browser, a gallery application, for example.

In the example of FIG. 2, the picture 203 is divided into a grid 206 comprising nine cells 204. In the example of FIG. 2 the grid 206 is faintly visible to a user. In another embodiment the grid 206 may be invisible to a user. In a yet further embodiment the grid 206 may be made visible and/or invisible in response to a user action. The user action may be selecting a setting that enables making the grid 206 visible and/or invisible, a depression on a hardware key, performing a touch gesture on a touch screen, selecting a programmable key with which making the grid 206 visible and/or invisible is associated or by any other suitable means. In a yet further embodiment the grid 206 is visible at the beginning when a user is learning to use the apparatus 100, but made invisible when the user is confident in using the apparatus 100. In one exemplary embodiment the processor 110 is configured to monitor a user's actions and determine a confidence level for a user with the device 100 or with a particular functionality of the device. A confidence level may be determined, for example, based on a number of mistakes made by a user or a number of wrong commands input by a user. In one exemplary embodiment, a user's actions are monitored by the processor 110, and in response to detecting one or more mistakes in using the apparatus 100, the grid 206 is made visible to the user. In another exemplary embodiment a pointing means such as a pointer, a finger, a stylus, a pen or any other suitable pointing means is detected hovering over a user interface object, and in response to detecting the hovering, the grid 206 is made visible to the user. In one exemplary embodiment, detecting a pointing means hovering over an object comprises detecting the pointing means in close proximity to the object. In another exemplary embodiment, detecting a pointing means hovering over a user interface object comprises detecting the direction of the pointing means and determining whether the pointing means points to the user interface object. In response to detecting the direction of the pointing means and determining that the pointing means points to the user interface object a grid 206 may be made visible to the user. In a further exemplary embodiment, detecting a pointing means hovering over a user interface object comprises detecting the pointing means in close proximity to the object, detecting the direction of the pointing means and determining whether the pointing means points to the user interface object. In response to detecting that the pointing means is in close proximity to the user interface object and detecting that the pointing means points to the user interface object, a grid 206 may be made visible to the user. In one exemplary embodiment, detecting a pointing means in close proximity to a user interface object comprises detecting whether the distance between the pointing means and the user interface object is less than a threshold value.

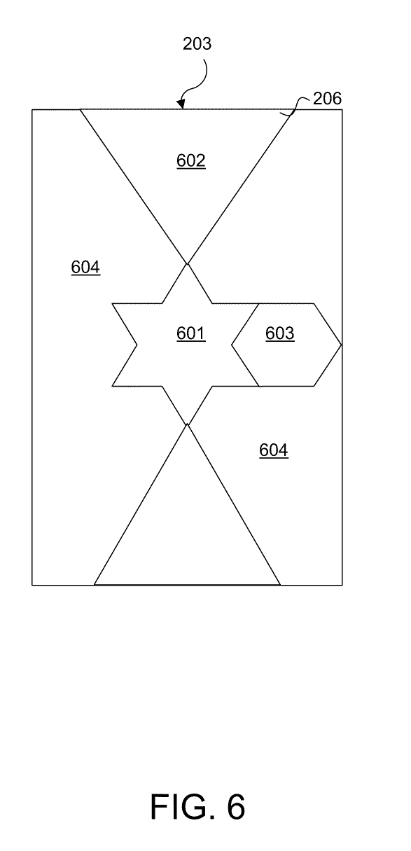

The exemplary grid 206 of FIG. 2 comprises nine cells where the sizes and shapes of the cells 204 in the grid 206 are the same. However, the sizes, the shapes and/or the number of the cells may be different for different user interface objects and/or different operations. According to one exemplary embodiment a grid 206 may comprise multiple shapes and/or an arrangement of lines that delineate a user interface object into cells. In the example of FIG. 6, a user interface object 203 is divided into multiple cells of different shapes. A shape of a cell may comprise a regular shape as a square, a triangle, a pentagon, a hexagon, a heptagon, an octagon, a star, a circle, an ellipse, a cross, a rectangle, an arrow. Alternatively or additionally, a shape of a cell may comprise any irregular shape. In the example of FIG. 6, a grid 206 comprises cells with a shape of a star 601, a triangle 602, a hexagon 603 and an irregular shape 604. According to one embodiment two or more neighboring cells of a grid 206 may be touching each other. According to another embodiment two or more neighboring cells of a grid may be separated in terms of not touching to each other.

According to one exemplary embodiment, the sizes, the shapes and/or the number of the cells may be updated dynamically based on user actions. For example, the processor 110 may be configured to monitor a user's behavior in terms of registering received commands, instructions and/or operations, the frequency of received commands, instructions and/or operations, and/or the latest received commands, instructions and/or operations. As an example, the processor 110 may be configured to make a cell 204 in the grid 206, with which an operation is associated, larger in size in response to detecting a frequently activated operation within the cell 204. Alternatively, the processor 110 may be configured to make a cell 204, with which an operation is associated, smaller in size in response to detecting inactivity within the cell for a pre-determined period. According to another exemplary embodiment, the processor 110 may be configured to change a shape of a cell, with which an operation is associated, to better fit with the form of a path or a touch gesture required for activating the operation associated with the cell. For example, if a zoom operation is activated by dragging a pointing means in a circular motion, the shape of a cell associated with the zoom functions may be made more circle like or even a full circle by the processor 110.

Referring back to the example of FIG. 2, the user interface object 203 is divided into a grid 206 comprising nine cells. An appropriate size of a grid 206 in terms of a number of cells 204 may be determined by the processor 110 based on, for example, a physical dimension of a user interface object, by a type of a user interface object, by a number of operations associated with a user interface object, by a type of an operation associated with a user interface object, or by a form of user input that is in use. According to another exemplary embodiment, the processor 110 is configured to adjust the number of cells according to a user's behavior by monitoring and registering a user's actions. For example, the processor may be configured to remove a cell from the grid 206 in response to detecting inactivity within the cell for a pre-determined period of time. In one exemplary embodiment the pre-determined time period comprises at least one of the following: a minute, an hour, a day, a week, a fortnight, a month and a year.

In the example of FIG. 2, a user interface object such as a picture 203 is divided into multiple cells. In one exemplary embodiment an operation is associated with each of the cells. In another exemplary embodiment an operation is associated with some of the cells. In a further exemplary embodiment more than one operation is associated with a cell. In a yet further example, a same operation may be associated with more than one cell.

According to one exemplary embodiment a cell with which an operation is associated may be visually indicated to a user by a different colour, by highlighting, by underlining, by means of an animation, a picture or any other suitable means. According to another exemplary embodiment, cells with which a same operation has been associated may be indicated to a user in a similar way. For example, if a zoom operation is associated with two different cells, the background colour on the cells may be the same. According to a further exemplary embodiment, a cell with which more than one operation is associated may be indicated to a user in a different manner from a cell with which one operation is associated.

In one exemplary embodiment the one or more operations associated with a cell 203 are dependent on the user interface object. The associated operations may depend on a physical dimension of the user interface object or a type of the user interface object. For example, if the user interface is a small object, for example the area of the user interface object is less than a pre-determined threshold value the grid 206 may comprise a smaller number of cells than a bigger user interface object, for example where the area of the user interface object is larger than a threshold value. The processor 110 may be configured to receive information on a physical dimension of a user interface object and determine a size of the grid 206 based on the received information. According to another exemplary embodiment a type of the user interface object may be detected by the processor 110 and operations are associated with cells by the processor 110 based on the detected type of the user interface object and instructions stored in the memory 160. For example, if the processor 110 detects that a user interface object is an application window 201, which by its nature is intended to remain in a fixed position on the display, the processor 110 may define based on instructions stored in the memory 160 that rotation of the application window 201 is not an allowed operation. According to a yet further exemplary embodiment the one or more operations associated with a cell and/or allowed to the user interface object are defined by a user. In one exemplary embodiment one or more predefined properties of a user interface object 203 may be changed in response to detecting an allowed operation to a user interface object. For example, in response to detecting that a scroll operation is allowed for the application window 201, the scroll bars 207 may be removed and the scroll operation may be associated with a cell.

The processor 110 may be configured to communicate with a user interface object and according to one exemplary embodiment the processor 110 receives instructions regarding one or more allowed operations to a user interface object from the user interface object itself. For example, if a user interface object is an application window 201, the processor may receive instructions from the application window 201 that define rotation of the window as not an allowed operation.

According to a yet further exemplary embodiment, one or more operations allowed for a user interface object may be changed dynamically by the processor 110. For example, if a user interface object is an application window 201 that comprises means 208 for switching between the application window and a full screen application, different operations may be allowed for the window mode and the full screen mode. According to one exemplary embodiment, the processor 110 is configured to dynamically change the operations associated with cells 204 of a user interface object in response to detecting a switch from a first mode of a user interface object to a second mode of the user interface object. According to another exemplary embodiment detecting a switch from a first mode of a user interface object to a second mode of the user interface object by the processor 110 also comprises detecting a type of the second user interface object and defining one or more operations allowed for the user interface object in the second mode based on the detected type.

According to one exemplary embodiment, dynamically changing operations associated with a user interface object comprise at least one of the following: adding a new operation, removing a previously associated operation, and replacing a previously associated operation with a new operation.

Any operations that are not allowed for a user interface object may according to one exemplary embodiment be replaced with other operations. In one embodiment, the other operations used for replacing any not allowed operations may be default operations, operations specific to the type of the user interface object, operations specific to the physical size of the user interface object, operations defined by a user, most frequently activated operations and/or operations activated most recently, for example.

In one example, an operation associated with a cell 204 may be activated by selecting a point in the cell by a pointing means and forming a pre-determined path or a touch gesture by dragging the pointing means on the display 140 or on a touch screen. According to one embodiment an operation remains activated until a user releases the pointing device irrespective of the end point of the formed path or touch gesture. According to yet another embodiment an operation is activated in response to detecting a starting point for the operation indicated by a pointing means. According to one exemplary embodiment, an operation comprises at least one of the following: zooming, scrolling, panning, moving, rotating and mirroring.

Referring back to the example of FIG. 2, not only the pictures 203 but also the map application 202 behind the pictures 203 may be divided into a grid comprising multiple cells. According to one exemplary embodiment an action associated with a cell may be activated by selecting a point on the map application 202, within the desired cell, by a pointing means and performing a pre-determined gesture by dragging the pointing means to essentially match to a pre-determined path.

According to one exemplary embodiment a user interface object 203 comprises at least one of the following: an application window, a full screen application, an icon, a task bar, a shortcut, a scroll bar, a picture, a note, a file, a folder, an item, a list, a menu and a widget.

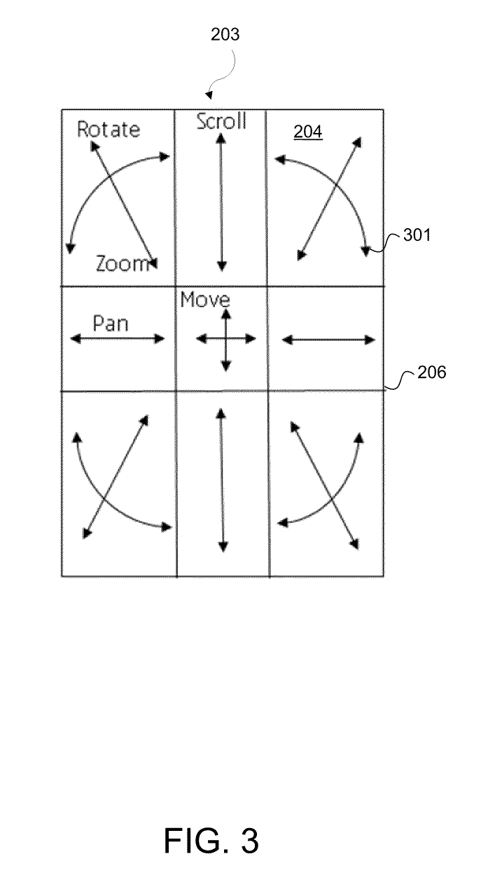

FIG. 3 illustrates a user interface object 203 divided into a grid in accordance with an example embodiment of the invention. The grid in the example of FIG. 3 comprises nine cells 204 to each of which one or more operations are associated 301. According to one exemplary embodiment the grid is visible to the user. According to another exemplary embodiment the grid is invisible to the user. According to a yet further exemplary embodiment the grid can be made visible and/or invisible in response to a user command.

The operations associated with the exemplary user interface object of FIG. 3 include rotating, zooming, scrolling, panning and moving. In response to detecting an action on one of the cells, an associated operation is performed on the user interface object.

According to one exemplary embodiment the user interface object of FIG. 3 is displayed on a touch screen. An operation to be performed on the user interface object may be selected by a finger, a stylus or any other suitable input means. Referring again to FIG. 3, detecting an action on a cell such as a touch on the middle cell at the top of the grid by an input means and dragging the input means up or down on the screen, scrolls the user interface object up or down, respectively.

According to another exemplary embodiment more than one operation may be associated with a cell 204. In one embodiment a type of the action may be determined by detecting a path of an input means on the screen. In another embodiment a type of the action may be determined based on the detection of a path of an input means and a starting point of the input means on the screen. In the example of FIG. 3, in response to detecting a curve clockwise or counter clockwise dragged by an input means, a rotating operation is activated clockwise or counter clockwise, respectively. In another embodiment, in response to detecting a diagonal path towards or away from the corner of the cell 204, the user interface object is zoomed out or in, respectively.

An operation associated with a cell may be performed even though a movement by the input means extends outside the cell. Referring back to the example of FIG. 3, a zooming function is activated on the cell at the top left by dragging an input means towards the center most cell, and extending the dragging outside the cell comprising the zooming function to the center most cell of the grid with which a moving function is associated. In this example the operation performed on the user interface object is zooming despite the fact that the dragging extended outside the cell at the top left. According to one exemplary embodiment an activated operation such as zooming, scrolling, panning or moving remains active for as long as the movement of the input means continues. In one exemplary embodiment the processor 110 is configured to detect a completion of a movement of an input means. In one exemplary embodiment completing a movement of an input means comprises detecting the input means being stationary for a pre-determined period of time. In another exemplary embodiment completing a movement of an input means comprises detecting releasing the input means from the touch screen. In yet a further exemplary embodiment completing a movement of an input means comprises detecting a long press on the touch screen. In a yet further exemplary embodiment completing a movement of an input means comprises detecting a press of a pre-defined intensity on the touch screen.

According to one exemplary embodiment, in response to detecting a touch of an input means on a cell, the operations associated with the cell are displayed. For example, a visual presentation of a path to cause an associated operation to be activated may be displayed within the cell for the user or a help text such as “zoom”, “rotate”, “scroll”, “pan” or “move” may be shown to the user within the cell.

According to one exemplary embodiment operations associated with cells are placed to support both left- and right-handed usage. Referring back to the example of FIG. 3, associating “rotate” and “zoom” operations to the corner cells of the grid enables both left- and right-handed usage. According to another exemplary embodiment operations associated with cells are placed to support intuitive usage of the operations. Again referring back to the example of FIG. 3, the operations associated with the cells may be placed to mimic center of gravity i.e. a move operation is placed in the middle, zoom operation is performed by dragging a pointer means towards or away from the middle and a rotate operation is activated by dragging a pointer means around the middle point. Also other ways of placing the operations in the cells 204 of the grid 206 are possible.

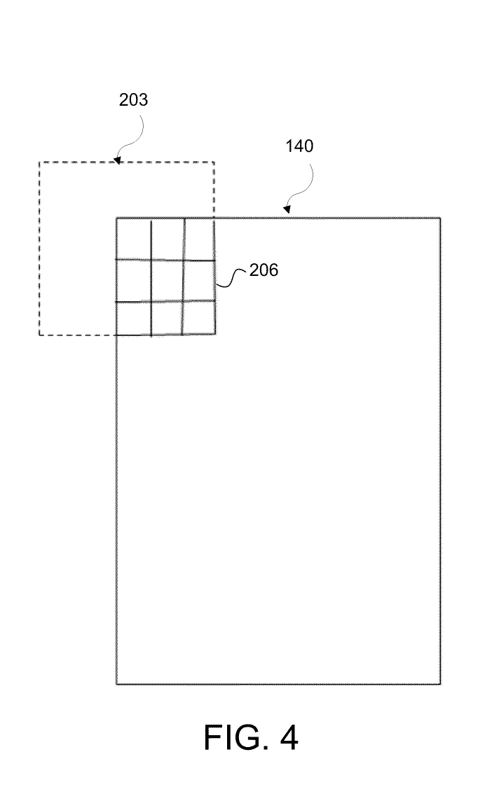

FIG. 4 illustrates another user interface object 203 divided into a grid 206 in accordance with an example embodiment of the invention. In the example of FIG. 4 only a part of the user interface object 203 is visible on the display 140. The invisible part of the user interface object 203 is illustrated with a dashed line in FIG. 4. According to one exemplary embodiment a visible part of a user interface object 203 is detected by the processor 110 and divided into a grid 206. According to another exemplary embodiment a user interface object 203 is divided into an updated grid 206 in response to processor 110 detecting moving of the user interface object 203 partially outside the display area 140 and/or in response to detecting moving of the user interface object 203 to reveal a larger area of the user interface object 203. According to a further exemplary embodiment a grid 206 is updated dynamically when a continuous movement of the user interface object 203 is detected by the processor 110. According to a yet further embodiment a grid 206 is updated in response to detecting an increase and/or a decrease in a visible area of a user interface object 203 by the processor 110. The increase and /or the decrease in a visible area of a user interface object may be a percentage value and/or an absolute value.

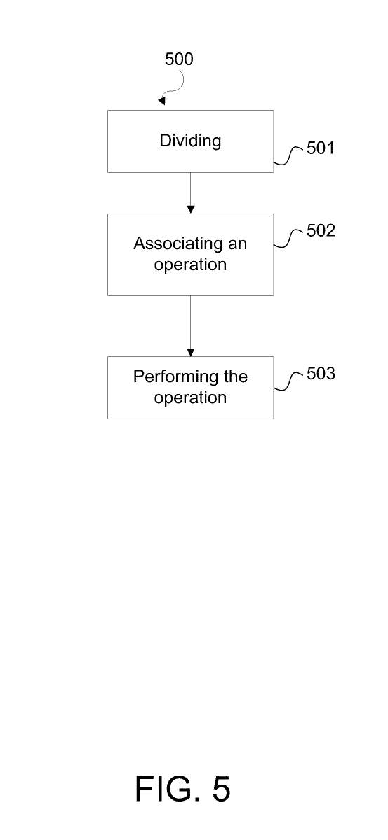

FIG. 5 illustrates an exemplary process 500 incorporating aspects of the disclosed embodiments. In a first aspect at least part of a user interface object is divided 501 into a grid comprising multiple cells, and an operation is associated 502 with a cell. In one exemplary embodiment a cell may comprise more than one operation. In another exemplary embodiment no operations may be associated with a cell. The operation associated with the cell may be performed 503 on the user interface object in response to detecting an action on the cell.

According to one exemplary embodiment an action on a cell may comprise a pointing action by a pointing means, a pointing and dragging action by a pointing means or a pointing, dragging and a lift action by a pointing means. According to another exemplary embodiment detecting an action on a cell may comprise detecting a starting point of an action within a cell. According to a yet further embodiment detecting an action on a cell may comprise a dragging gesture extending outside the cell. According to a yet further embodiment detecting an action on a cell may comprise a path extending outside the cell.

According to one exemplary embodiment a visible part of a user interface object is determined or detected by the processor 110. Information on the visible part may be updated, for example, in response to detecting moving of the user interface object 203 or in response to detecting a change in the visible area that is greater than a pre-determined threshold value. In one exemplary embodiment the pre-determined threshold value is a percentage value. In another exemplary embodiment the pre-determined threshold value is an absolute value.

According to one exemplary embodiment an operation associated with a cell is dependent on the user interface object 203. According to another exemplary embodiment an allowed operation for the user interface object 203 is defined by the user interface object 203 itself. The processor 110 may be configured to communicate with the user interface object to receive information regarding allowed and/or not allowed operations for the user interface object. Alternatively or additionally, the processor 110 may be configured to determine allowed and/or not allowed operations for a user interface object based on the type of the user interface object 203.

According to one exemplary embodiment a cell within a user interface object may comprise more than one operation. An operation may be activated by a dedicated action input by a user. In one exemplary embodiment a type of an action is determined based on a touch gesture made by a pointing device. In the example of FIG. 3, the corner cells 204 of the grid 206 comprise a rotate operation and a zoom operation. In response to detecting a touch gesture being of a circular motion by a pointing means, a rotate operation is activated. Alternatively, in response to detecting a touch gesture being of a diagonal motion a zoom operation is activated. In a further example, in response to detecting both a circular and a diagonal motion, both the rotate and the zoom operations are activated and the user interface object 203 is rotated and zoomed simultaneously. For example, in response to detecting a path comprising a diagonal path between the upper left corner and the lower right corner of the cell 204, and further comprising a diagonal path between lower left corner and the upper right corner of the cell 204, both zooming and rotating may be activated. In the example of FIG. 3, a path at the top left cell, the path comprising a diagonal path from the upper left corner towards the lower right corner may contribute to zooming in the user interface object 203 and a path comprising a diagonal path from the upper right corner towards the lower left corner may contribute to rotating the user interface object 203 counter clockwise. As a result, zooming in and rotating clockwise may be active at the same time. In some examples, a path activating more than one operation may be continuous. In some examples, a path activating more than one operation may be discontinuous.

According to one exemplary embodiment, in response to detecting any action on a cell 204 with which more than one operation is associated, a first operation may be activated. In one exemplary embodiment the first operation is a default operation. In another exemplary embodiment the first operation is the most frequently activated operation. In a further exemplary embodiment the first operation is the most recently activated operation. According to another exemplary embodiment, a user's actions may be monitored and if the user's actions suggest that a second operation associated with the cell was intended, an activated first operation may be stopped and a second operation may be activated.

According to one exemplary embodiment, a cell 204 with which more than one operation is associated, one of the operations may be a default operation. For example, a first operation and a second operation may be associated with a cell 204 of which operations the first operation may be a default operation that is activated in response to detecting any action on the cell 204. For example, referring back to FIG. 3, wherein the center most cell is associated with a move operation, moving the user interface object 203 left or right (X-direction) may be the default operation and moving the user interface 203 object up or down (Y-direction) may be a second operation. In response to detecting an action on the center most cell, coordinate values in an X-direction may be calculated and given as input to the associated left/right movement to move the user interface object 203 left/right. In this example, also coordinate values in a Y-direction may be calculated. In one example, a change in the coordinate values may be determined. In one exemplary embodiment, the coordinate values in the X-direction may be compared with the coordinate values in the Y-direction, and in response to detecting a change in the coordinate values in the Y-direction that is greater than a change in the coordinate values in the X-direction, the activated default operation may be stopped and the second operation may be activated. In another exemplary embodiment, in response to detecting an increase in the coordinate values in the Y-direction that is greater than an increase in the coordinate values in the X-direction, the default operation may still be continued. In a further exemplary embodiment, in response to activating the second operation Y-coordinate values may be given as input to the second operation. In a yet further embodiment, in response to activating the second operation also any previously calculated Y-coordinate values may be given as input to the second operation.

Without in any way limiting the scope, interpretation, or application of the claims appearing below, a technical effect of one or more of the example embodiments disclosed herein is that user interface objects may be controlled by a single touch of a pointing means. Dividing a user interface object into a grid can allow direct control of the user interface object. Another technical effect of one or more of the example embodiments disclosed herein is that less time may be needed to control a user interface object, because a user does not need to go deep into a menu to activate an operation. The most used and/or most relevant operations for the user interface object may be activated directly. Another technical effect of one or more of the example embodiments disclosed herein is that a user may have a better understanding of which user interface object he is about to control. When selecting controls in a menu it may not be always very clear for a user which user interface object is selected and will be controlled in response to selecting a control in a menu. Having the possible operations associated with a user interface object on the user interface object itself and activating an operation on top of the user interface object may give a user a better understanding that the operation that is activated actually controls the user interface object underneath the user action.

Embodiments of the present invention may be implemented in software, hardware, application logic or a combination of software, hardware and application logic. The software, application logic and/or hardware may reside on the apparatus, a separate device or a plurality of devices. If desired, part of the software, application logic and/or hardware may reside on the apparatus, part of the software, application logic and/or hardware may reside on a separate device, and part of the software, application logic and/or hardware may reside on a plurality of devices. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 1. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
dividing at least a part of a user interface object into a grid comprising multiple cells;
associating an operation with a cell in the grid; and
in response to detecting an action on the cell performing the associated operation on the user interface object.

2. A method according to claim 1, wherein the dividing at least part of the user interface object further comprises determining a visible part of the user interface object and dividing the visible part of the user interface object.

3-4. (canceled)

5. A method according to claim 1, wherein the associated operation is dependent upon at least a type of the user interface object.

6. A method according to claim 1, wherein the detecting an action on the cell comprises detecting a starting point of the action within the cell.

7. A method according to claim 1, wherein more than one operation is associated with the cell and the method further comprises determining a type of the action.

8. (canceled)

9. A method according to claim 1, wherein the action comprises a touch on a touch sensitive display.

10. A method according to claim 1, wherein the action comprises a dragging gesture extending outside the cell.

11-12. (canceled)

13. A method according to claim 1, wherein each of a plurality of cells in the grid is associated with an operation, such that any one of a plurality of operations may be performed by an action of the respective associated cell.

14. A method according to claim 13, wherein the action is a single touch gesture.

15. An apparatus, comprising:
a processor,
memory including computer program code, the memory and the computer program code configured to, working with the processor, cause the apparatus to perform at least the following:
divide at least a part of a user interface object into a grid comprising multiple cells;
associate an operation with a cell in the grid; and
perform the associated operation on the user interface object in response to detecting an action on the cell.

16. An apparatus according to claim 15, wherein in order to divide at least part of the user interface object the processor is further configured to determine a visible part of the user interface object and to divide the visible part of the user interface object.

17-18. (canceled)

19. An apparatus according to claim 15, wherein the associated operation is dependent upon at least a type of the user interface object.

20. An apparatus according to claim 15, wherein in order to detect an action on the cell the processor is configured to detect a starting point of the action within the cell.

21. An apparatus according to claim 15, wherein more than one operation is associated with the cell and the processor is further configured to determine a type of the action.

22-28. (canceled)

29. A computer program product comprising a computer-readable medium bearing computer program code embodied therein for use with a computer, the computer program code comprising:
code for dividing at least a part of a user interface object into a grid comprising multiple cells;
code for associating an operation with a cell in the grid; and
code for performing the associated operation on the user interface object in response to detecting an action on the cell.

30. A computer program product according to claim 29, wherein in order to divide at least part of the user interface object, the computer program product further comprises code for determining a visible part of the user interface object and dividing the visible part.

31. (canceled)

32. A computer program product according to claim 29, wherein the associated operation is dependent upon at least a type of the user interface object.

33. A computer program product according to claim 29, wherein in order to detect an action on the cell a computer program product comprises code for detecting a starting point of the action within the cell.

34. A computer program product according to claim 29, wherein more than one operation is associated with the cell and the computer program product further comprises code determining a type of the action.

35-38. (canceled)

39. An apparatus, comprising:
means for dividing at least a part of a user interface object into a grid comprising multiple cells;
means for associating an operation with a cell in the grid; and
means for performing the associated operation on the user interface object in response to detecting an action on the cell.
